(19) United States
(12) Patent Application Publication
(10) Pub. No.: US 2016/0334984 A1
(43) Pub. Date: Nov. 17, 2016

(54) HANDWRITING DEVICE, METHOD AND STORAGE MEDIUM

(71) Applicant: KABUSHIKI KAISHA TOSHIBA, Tokyo (JP)

(72) Inventors: Shogo Ikeda, Kunitachi Tokyo (JP); Tatsuo Yamaguchi, Kunitachi Tokyo (JP); Toshiyuki Yamagami, Fussa Tokyo (JP); Yukihiro Kurita, Kokubunji Tokyo (JP); Yuki Kanbe, Ome Tokyo (JP)

(21) Appl. No.: 15/057,643

(22) Filed: Mar. 1, 2016

(30) Foreign Application Priority Data
May 14, 2015 (JP) 2015-099077

(51) Int. Cl. G06F 3/0488; G06F 3/0481

(52) U.S. Cl. CPC G06F 3/04883; G06F 3/04817

(57) ABSTRACT

According to one embodiment, an electronic apparatus includes a display configured to detect a stroke inputted on a screen of the display, and a hardware processor configured to display, on the screen, an icon that, when selected, initiates creation of an apparatus group comprising at least the electronic apparatus. The electronic apparatus displays a document on the screen and modifies the document to include additional strokes in response to receiving the additional strokes. Some of the additional strokes are inputted on the screen and some other of the additional strokes are inputted on another electronic apparatus belonging to the same apparatus group.

### CROSS-REFERENCE TO RELATED APPLICATIONS

This application is based upon and claims the benefit of priority from Japanese Patent Application No. 2015-099077, filed May 14, 2015, the entire contents of which are incorporated herein by reference.

### FIELD

Embodiments described herein relate generally to an electronic device which enables handwriting.

### BACKGROUND

To allow the user to easily input characters, drawings, etc., an electronic device including a touch screen display has been developed. Characters, drawings, etc., are handwritten on the touch screen display with a dedicated stylus. For example, this type of electronic device is a notebook computer, a tablet computer, or a smart phone.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the embodiments. Throughout the drawings, reference numbers are re-used to indicate correspondence between referenced elements.

FIG. 1 is an exemplary perspective view showing the external appearance of an electronic device according to embodiments.

FIG. 2 exemplarily shows how electronic devices are connected in order to realize a collaboration function.

FIG. 3 exemplarily shows the outline of the data flow between electronic devices by the collaboration function.

FIG. 4 exemplarily shows how the screens of electronic devices are synchronized by the collaboration function.

FIG. 5 exemplarily shows stroke data input as handwriting in the electronic devices shown in FIG. 4, and the writers of the stroke data.

FIG. 6 exemplarily shows the outline of the flow of stroke data between the electronic device of the owner (user A) and the electronic devices of participants (user B and user C) by the collaboration function.

FIG. 7 exemplarily shows the outline of the flow of stroke data from the electronic device of the owner (user A) to the electronic devices of participants (user B and user C) by the collaboration function.

FIG. 8 exemplarily shows a document handwritten on a touch screen display.

FIG. 9 exemplarily shows stroke data corresponding to the handwritten document shown in FIG. 8.

FIG. 10 shows an example of the system configuration of a tablet.

FIG. 11 shows an example of the function configuration of a collaboration application program.

FIG. 12 shows an example of the data structure of document data stored in a nonvolatile memory.

FIG. 13 shows another example of the data structure of document data stored in the nonvolatile memory.

FIG. 14 exemplarily shows the flow of steps which are performed by the tablet when the collaboration application program is executed.

FIG. 15 exemplarily shows the flow of steps which are performed by the tablet when the collaboration application program is executed.

FIG. 16 shows an example of a top screen displayed on the screen of the tablet when the collaboration application program is activated.

FIG. 17 shows an example of a setting screen for group creation (basic setting) displayed on the screen of the tablet at the time of group creation.

FIG. 18 shows an example of a setting screen for group creation (advanced setting) displayed on the screen of the tablet at the time of group creation.

FIG. 19 shows another example of the setting screen for group creation (advanced setting) displayed on the screen of the tablet at the time of group creation.

FIG. 20 shows an example of the top screen which is displayed when a group search is finished on the top screen shown in FIG. 16.

FIG. 21 shows an example of a participation acceptance screen displayed on the screen of the owner.

FIG. 22A and FIG. 22B show an example in which the screen of the owner is synchronized with the screen of a participant by the collaboration function.

FIG. 23 shows an example of a history screen displayed on the screen of the tablet.

FIG. 24 exemplarily shows the flow of steps which are performed by the tablet when the collaboration application program is executed.

FIG. 25 exemplarily shows a page addition icon displayed on the screen of the tablet.

FIG. 26 exemplarily shows a page switch icon displayed on the screen of the tablet.

FIG. 27A and FIG. 27B exemplarily show the screen of the tablet in a laser-pointer mode.

FIG. 28 exemplarily shows the screen of the tablet in a preview mode.

FIG. 29 exemplarily shows a page deletion icon displayed on the screen of the tablet.

FIG. 30 exemplarily shows a synchronous mode icon displayed on the screen of the tablet.

FIG. 31 exemplarily shows the screen transition in association with the on/off state of a synchronous mode of the tablets of users in a group.

FIG. 32 exemplarily shows the screen transition in association with the on/off state of the synchronous mode of the tablets of users in a group.

### DETAILED DESCRIPTION

Various embodiments will be described hereinafter with reference to the accompanying drawings.

[Introduction]

Handwriting can be input with a dedicated stylus on a display of an electronic device. The electronic device can allow a user to easily input characters, drawings, etc. In addition, to allow the user to easily share the handwriting with electronic devices in an apparatus group, the electronic devices can have a function to share the handwriting. The handwriting inputted on one of the electronic device is transmitted to other electronic devices in the apparatus group. If participants of a meeting have the electronic devices, the participants can use the electronic devices as a virtual white board. Documents made on the virtual white board in past meetings may be used or updated in new meeting. Some persons having the electronic apparatus may participate in the middle of the meeting and share the handwriting.

[Electronic device configuration]

FIG. 1 is a perspective view showing the external appearance of an electronic device according to embodiments. The electronic device is, for example, a stylus-based portable electronic device which enables handwriting using a stylus or a finger. The electronic device may be realized as, for example, a tablet computer or a slate computer (hereinafter, referred to as a tablet), a notebook computer, a smart phone or a PDA. Here, the electronic device is assumed to be a tablet 10. However, the electronic device is not limited to this example and may be other types of electronic devices.

The tablet 10 includes a main body 11 which is a housing having a thin-box shape. A touch screen display 17 is stacked on the upper surface of the main body 11. A flat-panel display and a sensor are incorporated into the touch screen display 17. The sensor detects the position (contact position) in which a stylus or a finger contacts the screen of the flat-panel display. The flat-panel display may be, for example, a liquid crystal display (LCD).

For the sensor, for example, a capacitive touch panel or an electromagnetic induction digitizer may be used. Here, it is assumed that both of the two sensors, which are a digitizer and a touch panel, are incorporated into the touch screen display 17. However, only one of the two sensors may be incorporated into the touch screen display 17. When both of the two sensors are incorporated, the touch screen display 17 is configured to detect both the contact position of a finger on the screen and the contact position of a stylus on the screen. A stylus 100 may be, for example, an electromagnetic induction stylus (digitizer stylus). The user can handwrite characters, etc., on the screen of the touch screen display 17, using the stylus 100. During handwriting, the movement of the stylus 100 on the screen is drawn as a handwritten stroke on the screen in real time. Each handwritten strokes may be defined by each pen down to pen up. The movement of the stylus 100 in a contact period of the stylus 100 on the screen is equivalent to one stroke. The assembly of many strokes constituting handwritten characters or drawings forms a handwritten document. A handwritten document may be managed as a document file containing a plurality of pages each corresponding to one screen. Alternatively, a handwritten document may be managed as a file formed by a one-page canvas larger than the screen, and the canvas may be partially displayed on the screen.

One stroke is shown by stroke data structured by the assembly of a plurality of point data items corresponding to a plurality of points on the stroke, respectively. Each point data item indicates the coordinates (x- and y-coordinates) of the corresponding point.

In addition to the above handwriting function, the tablet 10 may have a collaboration function. The collaboration function may allow a plurality of electronic devices or their users to form a group and enables all the electronic devices in the group to be synchronized with each other in terms of handwriting operations and screen displays such that some or all the users in the group can collaborate to prepare a handwritten document. Specifically, data input in an electronic device in a group is distributed to all the other electronic devices in the group. By this distribution, the handwritten document displayed on the display screen is synchronized in all the electronic devices in the group. In this manner, some or all the users in a group can share a handwritten document in their electronic devices, view the shared handwritten document and edit (for example, additionally input data in) the handwritten document by collaboration work with each other.

The users of electronic devices in a group, in other words, the members of a group, may include an owner (organizer) and one or more participants. The owner is a user who creates a group to share a document and invites members (participants) to the created group. The owner may have a power different from that of the other members (participants). For example, The owner can judge a permission or a rejection to a request for participating the created group but the other members cannot Thus, the device of the owner functions as a host or a server, and the device of each participant functions as a client. The device of each participant is connected to the device of the owner to exchange data between them. The devices of the participants are synchronized with each other via the device of the owner. The devices of the participants are not connected to each other.

The shared document is not limited to a handwritten document and may be text data, an image data, presentation data, word-processing data or spreadsheet data with handwriting. The shared document is updated with time. The document which is shared at the time of group creation may be a new document or may be a document stored in local storage.

Data which is input by a plurality of users, for example, handwritten strokes, may be displayed (for example, in different colors) such that the user who made each stroke can be identified. The stroke which is currently input or the latest stroke may be displayed in a form different from that of the previous strokes. Alternatively, a stroke which was input a certain period (for example, ten seconds) before the current time may be displayed in a form different from that of the other strokes.

[System configuration]

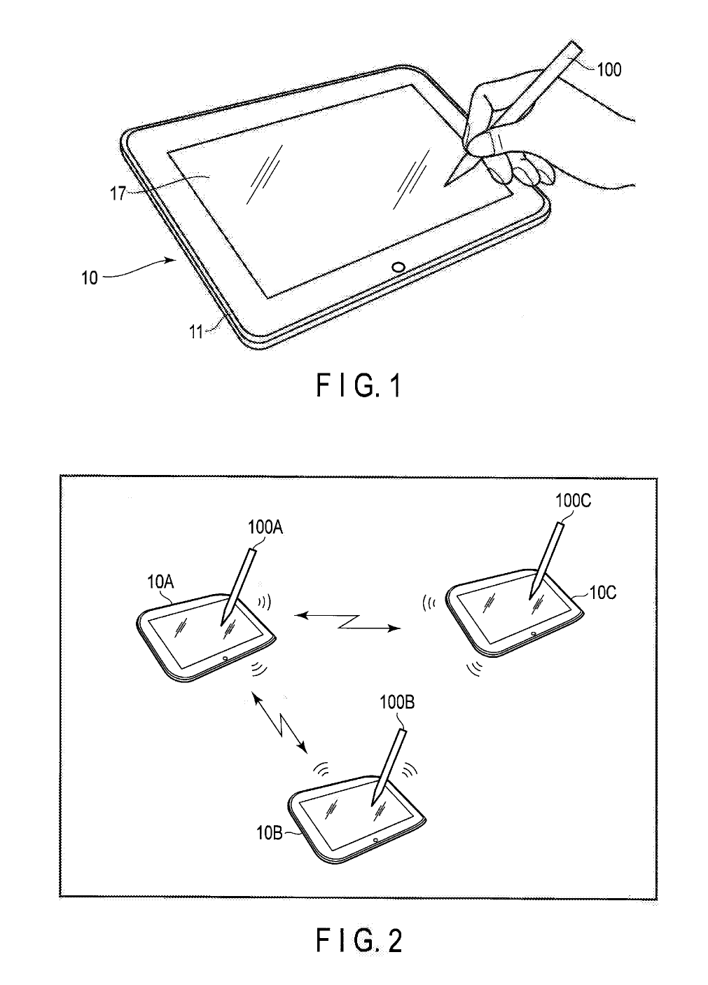

FIG. 2 exemplarily shows how a plurality of electronic devices are connected in order to realize the collaboration function. Tablets 10A, 10B and 100 are used by users A, B and C, respectively. Styluses 100A, 100B and 100C are attached to tablets 10A, 10B and 10C, respectively. Users A, B and C form a group to execute a collaboration operation. In the group, user A is the owner, and users B and C are the participants. For example, tablet 10A of the owner is wirelessly connected to tablets 10B and 100 of the participants. The connection between the tablets may be wired. When the tablets are wirelessly connected, an arbitrary wireless communication standard which allows two devices to be directly connected to each other may be used; for example, Bluetooth (registered trademark) or Wi-Fi Direct (registered trademark) may be used. However, the wireless connection between two devices is not limited to direct connection and may be wireless LAN (Wi-Fi [registered trademark]) connection via a router or an access point.

The owner is able to create a group, invite participants, open a document to be shared and accept or refuse a request from a user to participate in the group created by the owner. The shared document may be newly prepared at the time of group creation, or may be a document which was prepared in the past and stored in local storage. A participation request and acceptance/refusal may be based on the ID of the device itself or the ID of the user. Only the users accepted by the owner can participate in the group. The devices of the members of the group share a document. Further, the screens are synchronized in the devices. Any user can become the owner of a group. When a user creates a group, the user becomes the owner of the group. This user is a participant in a group created by another user. A user cannot become an owner and a participant at the same time. However, a user who was the owner of a group in the past can currently become a participant in another group. Conversely, a user who was a participant in a group in the past can currently become the owner of another group.

A participant in a group can leave the group at an arbitrary time point and finish sharing the document. When a participant performs a manual operation for leaving the group such as an operation of a group leave icon (not shown), the connection with the electronic device of the owner is lost. In this manner, the participant can leave the group. Even if a participant left the group, the group continues as long as at least one participant remains. Further, sharing of the document continues between the other participants and the owner. The owner can also finish sharing the document. However, when the owner left the group, sharing among all the participants is finished, and the group disappears. In addition, when all the participants left the group, the group disappears. Apart from a manual operation by the user, when the device of a participant is disconnected from the device of the owner because of a network error, etc., sharing of the document is finished. If a device left the group, the device stores, in local storage, document data which was shared when the device left the group. A document stored in local storage may be used as the initial document at the time of group creation as explained above.

When users B and C of tablets 10B and 100 participate in the group created by user A of tablet 10A, one handwritten document is shared and is displayed on the screen in each of tablets 10A, 10B and 10C. The handwritten document may contain a plurality of pages. Users A, B and C can freely view the shared handwritten document, switch the page and edit (for example, additionally input data in) the document. Therefore, a different page may be viewed by users A, B and C. An operation of editing the handwritten document is not limited to additional input of a handwritten stroke, and includes attachment of a text, a table, an image, etc., from another application to the handwritten document.

[Data flow in the system]

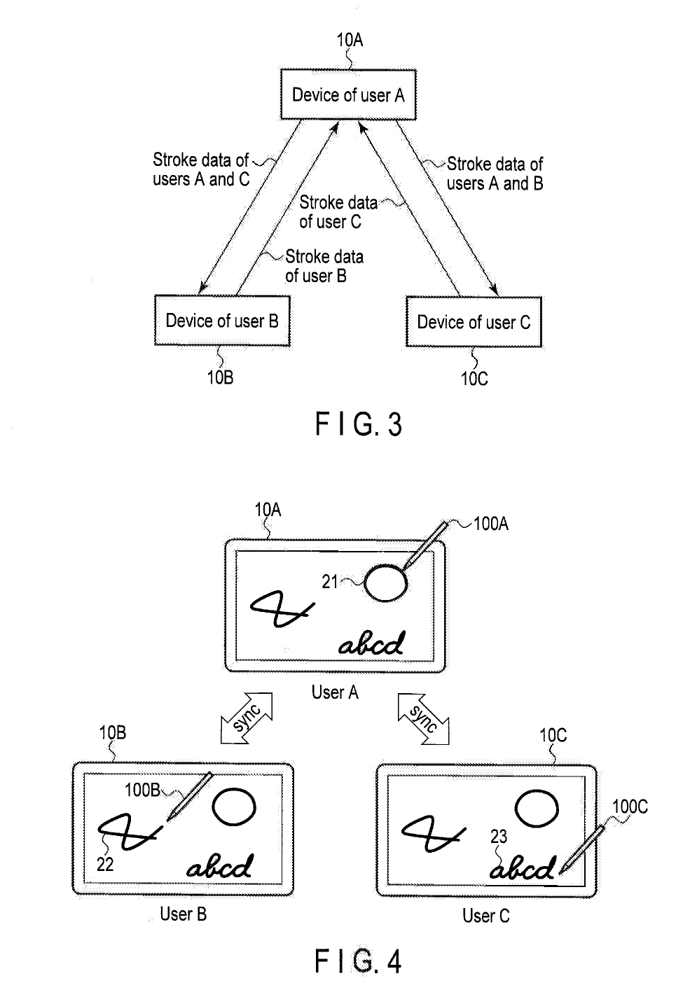

FIG. 3 shows the data flow between tablets 10A, 10B and 10C which are the users' devices when user A is the owner. Tablet 10A of user A receives the stroke data of user B from tablet 10B and receives the stroke data of user C from tablet 10C. Tablet 10A of user A transmits the stroke data input by user A as handwriting and the stroke data of user B received from tablet 10B to tablet 10C of user C. Tablet 10A of user A transmits the stroke data input by user A as handwriting and the stroke data of user C received from tablet 10C to tablet 10B of user B.

[Sharing handwriting and stroke data]

Thus, as shown in FIG. 4, stroke 21 handwritten on the screen of tablet 10A by user A with stylus 100A is displayed on the screen of tablet 10A and is also displayed on the screens of tablets 10B and 10C. In a similar manner, stroke 22 handwritten on the screen of tablet 10B by user B with stylus 100B is displayed on the screen of tablet 10B and is also displayed on the screens of tablets 10A and 10C. Stroke 23 handwritten on the screen of tablet 100 by user C with stylus 100C is displayed on the screen of tablet 10C and is also displayed on the screens of tablets 10A and 10B.

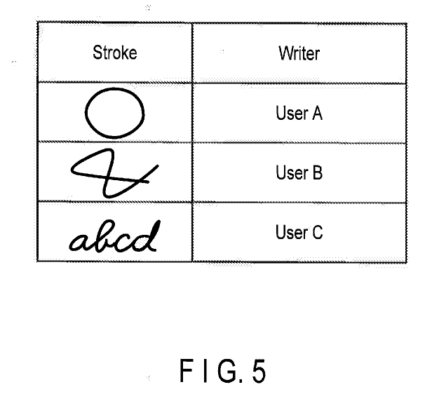

As shown in FIG. 5, the user name showing the writer is associated with each stroke data item as attribute data. A plurality of users collaborate with each other in editing the handwritten document. Based on attribute data, it is possible to specify the writer and prohibit the users other than the writer from deleting the stroke.

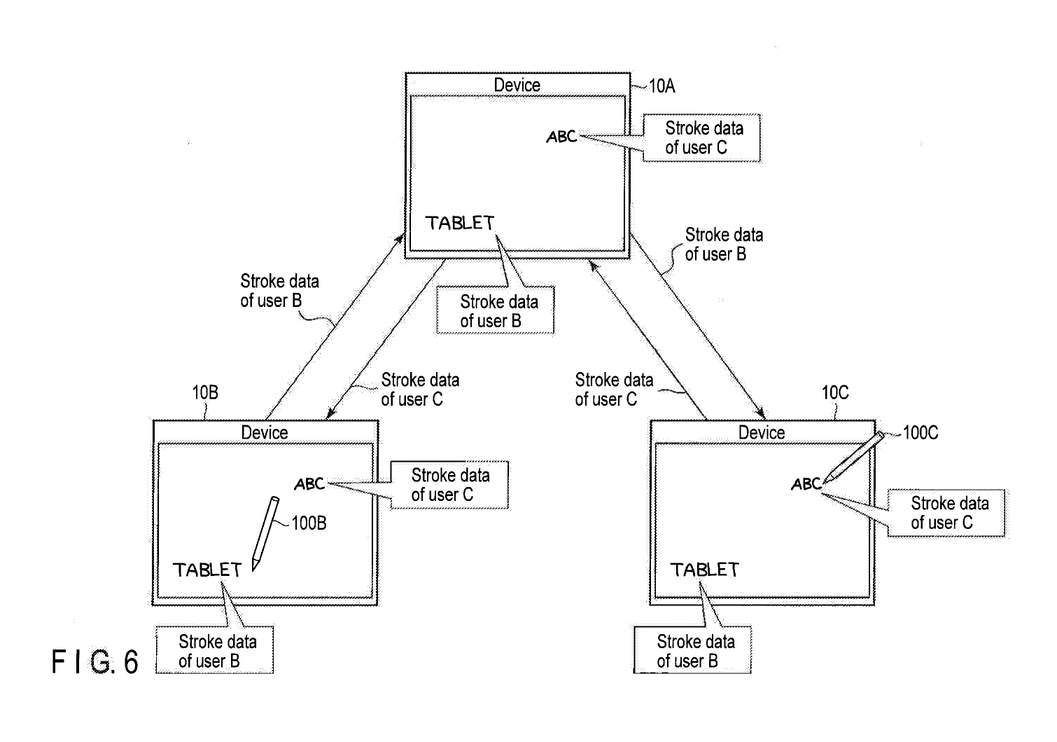

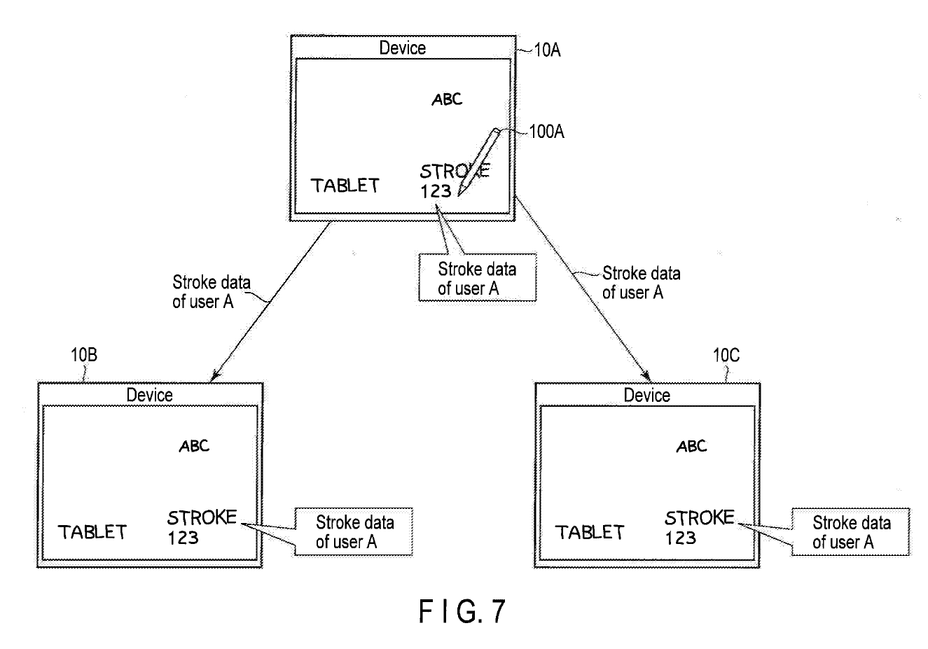

Now, with reference to FIG. 6 and FIG. 7, this specification explains the operations of device (tablet) 10A of user A who is the owner and devices (tablets) 10B and 10C of users B and C who are participants at the time of execution of the above collaboration function.

As shown in FIG. 6, when user B who is a participant handwrites a character string, for example, “TABLET”, on the screen of tablet 10B with stylus 100B, the handwritten stroke data of user B is wirelessly transmitted from tablet 10B to tablet 10A. On tablet 10A, the character string “TABLET” corresponding to the stroke data of user B transmitted from tablet 10B is displayed in the same position as the display position of the screen of tablet 10B. In addition, the stroke data of user B is wirelessly transmitted from tablet 10A to tablet 10C of a participant (here, user C) other than user B. On tablet 10C, the character string “TABLET” corresponding to the stroke data of user B transmitted from tablet 10A is displayed in the same position as the display position of the screen of tablet 10B. By the collaboration function, the character string “TABLET” handwritten on the tablet of a participant, for example, tablet 10B of user B, is displayed in the same positions on the screens of tablets 10A, 10B and 10C as shown in FIG. 6.

On the other hand, when user C who is another participant handwrites a character string, for example, “ABC”, on the screen of tablet 10C with stylus 100C, the handwritten stroke data of user C is wirelessly transmitted from tablet 10C to tablet 10A. On tablet 10A, the character string “ABC” corresponding to the stroke data of user C transmitted from tablet 10C is displayed in the same position as the display position of the screen of tablet 10C. In addition, the stroke data of user C is wirelessly transmitted from tablet 10A to tablet 10B of a participant (here, user B) other than user C. On tablet 10B, the character string “ABC” corresponding to the stroke data of user C transmitted from tablet 10A is displayed in the same position as that of the display screen of tablet 10A. By the collaboration function, the character string “ABC” handwritten on the tablet of another participant, for example, tablet 10C of user C, is displayed in the same positions on the screens of tablets 10A, 10B and 10C as shown in FIG. 6.

As shown in FIG. 7, when user A who is the owner handwrites a character string, for example, “STROKE123”, on the screen of tablet 10A with stylus 100A, the handwritten stroke data is wirelessly transmitted from tablet 10A to tablets 10B and 10C. On tablet 10B, the character string “STROKE123” corresponding to the stroke data of user A transmitted from tablet 10A is displayed in the same position as that of the display screen of tablet 10A. In a similar manner, on tablet 10C, the character string “STROKE123” corresponding to the stroke data of user A is displayed in the same position as that of the display screen of tablet 10A. By the collaboration function, the character string “STROKE123” handwritten on, for example, tablet 10A of user A who is the owner is displayed in the same positions on the screens of tablets 10A, 10B and 10C as shown in FIG. 7.

FIG. 6 and FIG. 7 are explained such that wireless communication is performed only between tablet 10A and tablet 10B and between tablet 10A and tablet 10C. However, for example, users B and C (or tablets 10B and 10C used by users B and C) who participate in the group are managed on tablet 10A which operates as a host. Therefore, tablet 10B may wirelessly and directly communicate with tablet 10C. Further, wireless communication may be performed under management of an external server such as an authentication server.

The device of the owner may not separately transmit stroke data to the devices of participants. Instead, stroke data may be simultaneously transmitted to all the devices by broadcasting. In this case, the devices which participate in the group manage key information to use (display, etc.,) stroke data. Thus, even when stroke data is transmitted by broadcasting, the stroke data can be used only in the devices which participate in the group.

[Data structure of stroke data]

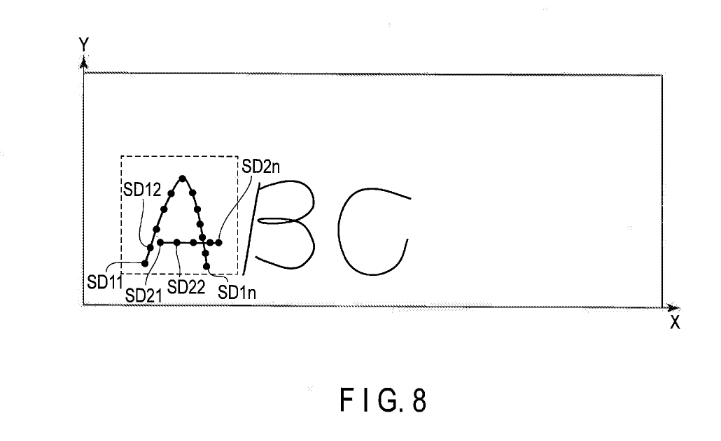

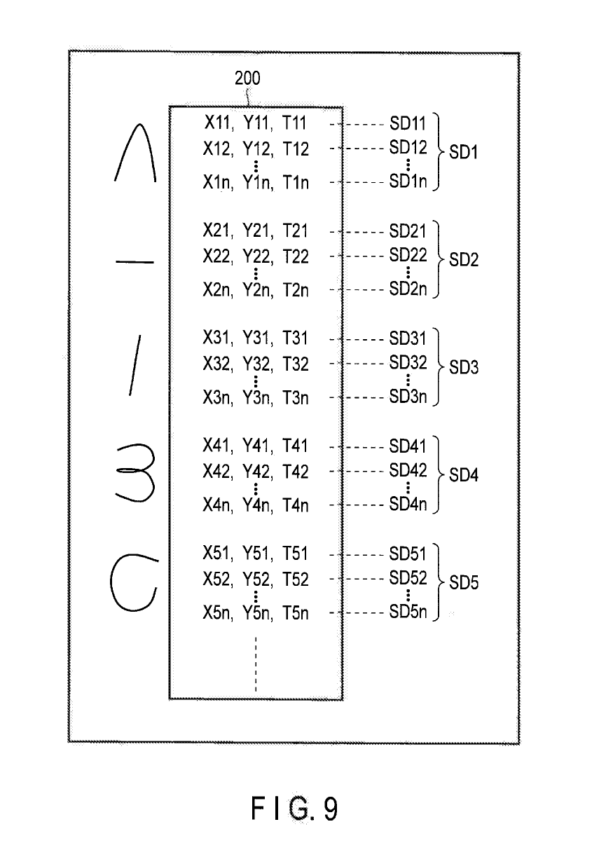

Now, this specification explains the relationships between characters, marks, drawings (lines), tables, etc., handwritten by the user and a document file with reference to FIG. 8 and FIG. 9. FIG. 8 shows an example of a handwritten character string. FIG. 9 shows the stroke data of the character string shown in FIG. 8. The handwritten character “A” is shown by two strokes (the stroke having the shape of “ [symbol] ” and the stroke having the shape of “−”). For example, each stroke is sampled in real time at equal time intervals. Stroke data is shown by the assembly of data of a plurality of sample points. As each stroke is sampled at equal time intervals, the number of sample points of one stroke differs depending on the stroke data. The longer the stroke is, or the slower the handwriting speed of the stroke is, the more sample points are obtained.

Each sample point data item indicates the X- and Y-coordinates of the corresponding sample point. For example, sample point data item SD11 indicates the x-coordinate (X11) and the y-coordinate (Y11) of the starting point of the stroke having the shape of “ [symbol] ”. SD1n indicates the x-coordinate (X1n) and the y-coordinate (Y1n) of the end point of the stroke having the shape of “ [symbol] ”. Each sample point data item may further include timestamp data T corresponding to the time when the sample point is handwritten. Moreover, data Z indicating the writing pressure may be included in each sample point data item. The writing pressure data is detected by the stylus 100 and is transmitted from the stylus 100 to the touch screen display 17 side. It is possible to handwrite and display expressive characters by changing the line thickness in accordance with the writing pressure.

FIG. 9 shows a document file 200 corresponding to the handwritten character string shown in FIG. 8. The document file 200 includes a plurality of stroke data items SD1, SD2, . . . , SD5. In the document file 200, these stroke data items SD1, SD2, . . . , SD5 are arranged in the chronological order in which the strokes are made.

In the document file 200, the first and second stroke data items SD1 and SD2 indicate the two strokes of the handwritten character “A”. The third and fourth stroke data items SD3 and SD4 indicate the two strokes constituting the handwritten character “B”, respectively. The fifth stroke data item SD5 indicates the stroke constituting the handwritten character “C”.

Each of stroke data items SD1, . . . , SD5 includes a series of sample point data items (time-series coordinates) corresponding to one stroke; in other words, a plurality of coordinates corresponding to a plurality of sample points on one stroke, respectively. In each stroke data item SD, a plurality of coordinates are arranged in the chronological order in which the stroke is made. For example, with regard to the handwritten character “A”, stroke data item SD1 includes a series of sample point data items (time-series coordinates) each corresponding to a sample point on the stroke having the shape of “ [symbol] ” of the character “A”. In other words, stroke data item SD1 includes n sample point data items SD11, SD12, . . . , SD1n. Stroke data item SD2 includes a series of sample point data items each corresponding to a sample point on the stroke having the shape of “−” of the character “A”. In other words, stroke data item SD2 includes n sample point data items SD21, SD22, . . . , SD2n. The number “n” changes depending on the length or the handwriting speed of the stroke.

[Electronic device configuration (detail)]

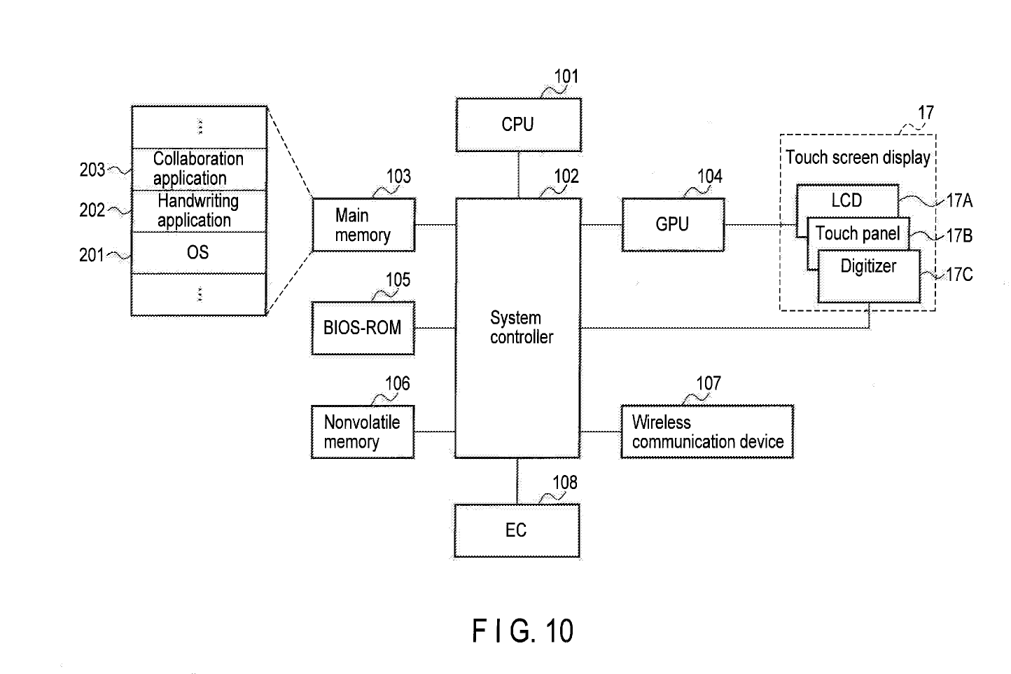

FIG. 10 shows the system configuration of tablets 10A, 10B and 10C (they may be collectively called the tablet 10 since they have the same configuration).

The tablet 10 includes, for example, a CPU 101, a system controller 102, a main memory 103, a graphics controller (GPU) 104, a BIOS-ROM 105, a nonvolatile memory 106, a wireless communication device 107 and an embedded controller (EC) 108.

The CPU 101 is a processor configured to control the operations of various modules of the tablet 10. The CPU 101 executes various computer programs loaded from the nonvolatile semiconductor memory 106 which is a storage device to the main memory 103. The computer programs include an operating system (OS) 201 and various application programs. The application programs include, for example, a handwriting application program 202 and a collaboration application program 203. The handwriting application program 202 has a function for preparing and displaying a handwritten document, a function for editing a handwritten document, etc. The collaboration application program 203 uses a part of the handwriting application program 202 and performs the above synchronous process between the tablets 10 in the group.

The CPU 101 also executes a Basic Input/Output System (BIOS) stored in the BIOS-ROM 105. The BIOS is a program for hardware control.

The system controller 102 is a device configured to connect a local bus of the CPU 101 and various components. The system controller 102 includes a built-in memory controller configured to control the access to the main memory 103. The system controller 102 has a function for communicating with the graphics controller 104 through a serial bus conforming to the PCI EXPRESS standard, etc.

The graphics controller 104 is a display controller configured to control an LCD 17A used as a display monitor of the tablet 10. A display signal generated by the graphics controller 104 is sent to the LCD 17A. The LCD 17A displays a screen image based on the display signal. A touch panel 17B and a digitizer 17C are provided on the LCD 17A. The touch panel 17B is a capacitive pointing device for inputting data on the screen of the LCD 17A. The touch panel 17B detects the contact position of a finger on the screen, the movement of the contact position, etc. The digitizer 17C is an electromagnetic induction pointing device for inputting data on the screen of the LCD 17A. The digitizer 17C detects the contact position of the stylus 100 on the screen, the movement of the contact position, etc.

The wireless communication device 107 is configured to perform wireless communication using, for example, a wireless LAN or 3G mobile communication. The tablet 10 may be connected to another tablet via a router (or an access point) by the wireless communication device 107 or may be directly connected to another tablet by the wireless communication device 107. The EC 108 is a single-chip microcomputer including an embedded controller for power management. The EC 108 has a function for switching the tablet computer 10 on or off in response to the operation of a power button by the user.

[Application configuration]

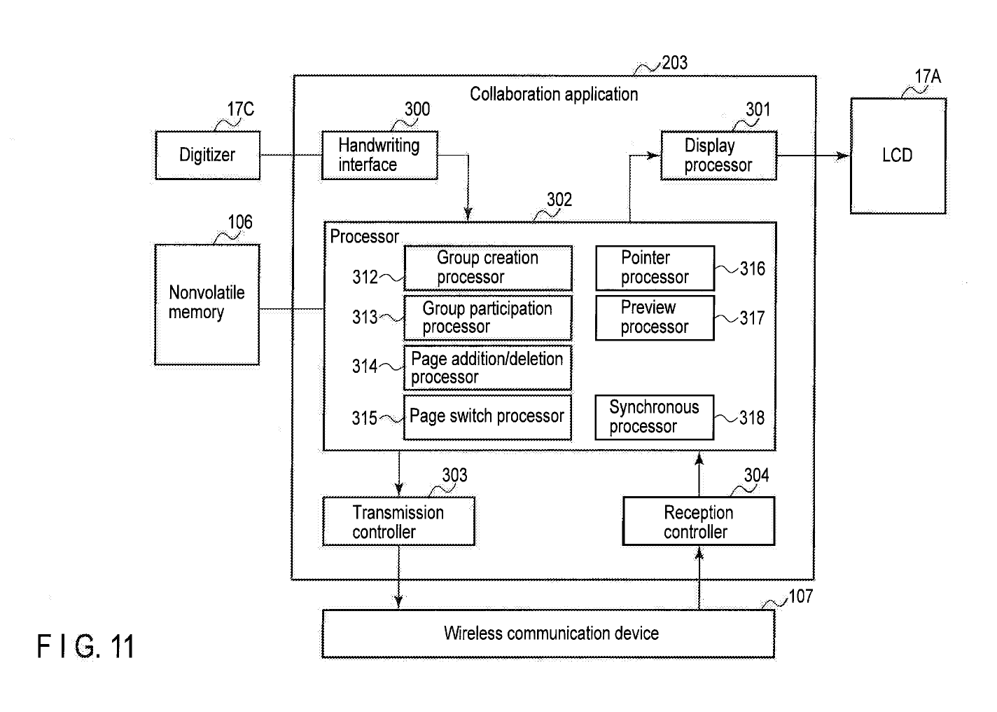

Now, the function configuration of the collaboration application program 203 is explained with reference to FIG. 11. The collaboration application program 203 includes, as function execution modules for sharing a handwritten document with another tablet, a handwriting interface 300, a display processor 301, a processor 302, a transmission controller 303, a reception controller 304 and the like. Handwritten document data is prepared, displayed, edited, etc., using stroke data input as handwriting on the touch screen display 17 with the stylus 100. The digitizer 17C of the touch screen display 17 detects the generation of events “touch”, “move (slide)”, “release”, etc., of the stylus 100. The event “touch” is an event indicating that the stylus 100 contacts the screen. The event “move (slide)” is an event indicating that the contact position is moved while the stylus 100 contacts the screen. The event “release” is an event indicating that the stylus 100 is separated from the screen.

The handwriting interface 300 is configured to perform handwriting input in collaboration with the digitizer 17C of the touch screen display 17. The handwriting interface 300 uses a part of the handwriting application program 202. The handwriting interface 300 receives the event “touch” or “move (slide)” from the digitizer 17C of the touch screen display 17 and detects a handwriting operation. The event “touch” includes the coordinates of the contact position. The event “move (slide)” includes the coordinates of the contact position of the destination of the move. Thus, the handwriting interface 300 receives a series of coordinates (a plurality of sample point data items) corresponding to the move of the contact position from the touch screen display 17 at regular time intervals.

The display processor 301 displays each stroke handwritten with the stylus 100 on the LCD 17A based on the series of coordinates output from the handwriting interface 300. The display processor 301 is configured to display strokes handwritten on another electronic device on the LCD 17A under control of the processor 302. The display processor 301 is further configured to display a handwritten document stored in the nonvolatile memory 106 on the LCD 17A.

The transmission controller 303 transmits the stroke data of the handwritten document displayed on the LCD 17A to another electronic device via the wireless communication device 107. The reception controller 304 receives stroke data transmitted from another electronic device via the wireless communication device 107.

The processor 302 performs a process for sharing a handwritten document with another electronic device. The processor 302 includes, for example, a group creation processor 312, a group participation processor 313, a page addition/deletion processor 314, a page switch processor 315, a pointer processor 316, a preview processor 317 and a synchronous processor 318. The processor 302 stores stroke data received from another tablet in the nonvolatile memory 106 as a document file.

The group creation processor 312 performs setting for creating a group of users who share a handwritten document. The user who creates a group is the owner of the group. The tablet of the owner functions as a host or a server regarding the collaboration operation of the group. The users other than the owner may be a participant in the group. The tablet of each participant functions as a client regarding the collaboration operation of the group. The group creation processor 312 is configured to determine whether or not a request from a user to participant in the group should be accepted. The group participation processor 313 transmits a request for participation in a group created by another user (owner) to the tablet of the owner. When the request is accepted, the group participation processor 313 performs a process for participating in the group.

The page addition/deletion processor 314 is configured to add a new page to the handwritten document or delete an arbitrary page from the handwritten document. Only the owner of the group which shares the handwritten document may be able to add or delete a page. The participants of the group may not be able to add or delete a page. The page switch processor 315 is configured to switch the page of the handwritten document displayed on the LCD 17A when the handwritten document contains a plurality of pages. Page switching can be performed by the participants as well as the owner.

The pointer processor 316 enables the stylus to be used as a laser pointer instead of a writing instrument. In a normal mode, the movement of the stylus is displayed as it is as a stroke on the touch screen display. In a pointer mode, a mark not connected with the movement of the stylus, such as a small circle, is displayed on the touch screen display. If a user points to a portion on the screen when the same screen is viewed by a plurality of users, a small circle is displayed in the pointed-to portion. The small circle is displayed even if the stylus point slightly oscillates. The small circle is also displayed on the screens viewed by the other users. Thus, it is possible to direct the attention of the other users to an arbitrary portion specified by a user on the screen when a large number of users view the same screen on their respective touch screen displays.

When a handwritten document including a plurality of pages is displayed, the preview processor 317 displays the selected page of the document in full-screen in a normal mode. In a preview mode, the page which is displayed in full-screen is scaled down. Further, a plurality of, for example, four reduced-size pages are arranged and displayed in the space. Since a plurality of pages are simultaneously displayed, the user-convenience is improved at the time of page switching, deletion, etc.

The synchronous processor 318 synchronizes the screens of the tablets of all the users in a group. The synchronous process includes a function for switching the page displayed on the tablet of each participant in association with switching of the page displayed on the tablet of the owner. The synchronous process further includes a function for making the page displayed on the tablet of each participant coincide with the page displayed on the tablet of the owner when the page displayed on the tablet of the participant does not coincide with the page displayed on the tablet of the owner because of page switching.

[Data structure of a shared document]

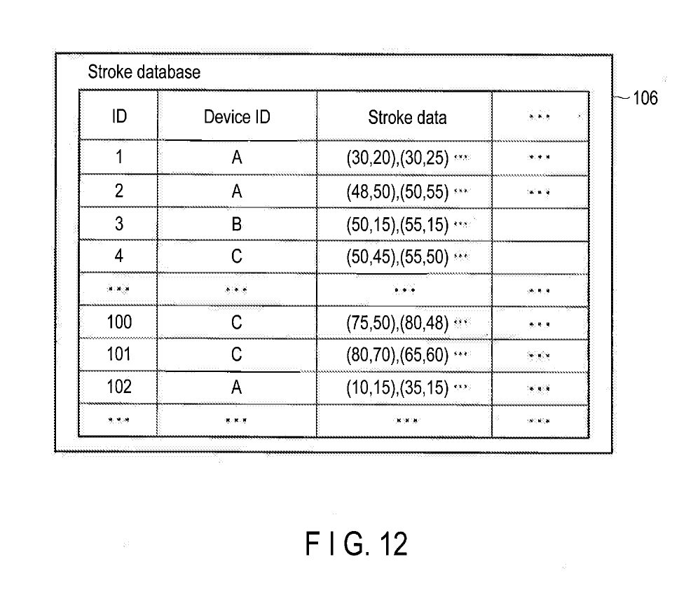

FIG. 12 shows an example of the data structure of a document file stored in the nonvolatile memory 106. One document file is shared by the users of one group. A document file is stored in the tablets of all the users who share the file. The identification data of the document file and the identification data of the group may be common. The document file is stored as a stroke database in the nonvolatile memory 106 as local storage. The stroke database includes a large number of records (a large number of storage regions) each having an allocated record ID. One record (one row in FIG. 12) corresponds to one stroke data item. For example, the device ID of a tablet and a stroke data item (a series of coordinates) are stored in each record. When stroke data is transmitted from each tablet, its device ID is transmitted together with the stroke data. To simplify the drawings, the timestamp data of stroke data is omitted in the drawings. For example, a user ID corresponding to stroke data (in other words, an identifier for identifying the user who input stroke data) and a stylus ID may be stored in each record.

Stroke data which is input by user A on the tablet device 10 (in short, device 10A) identified by device ID=A is stored in the record having record ID=1, 2 or 102. Stroke data which is input by user B on the tablet device 10 (in short, device 10B) identified by device ID=B is stored in the record having record ID=3. Stroke data which is input by user C on the tablet device 10 (in short, device 10C) identified by device ID=C is stored in the record having record ID=4, 100 or 101.

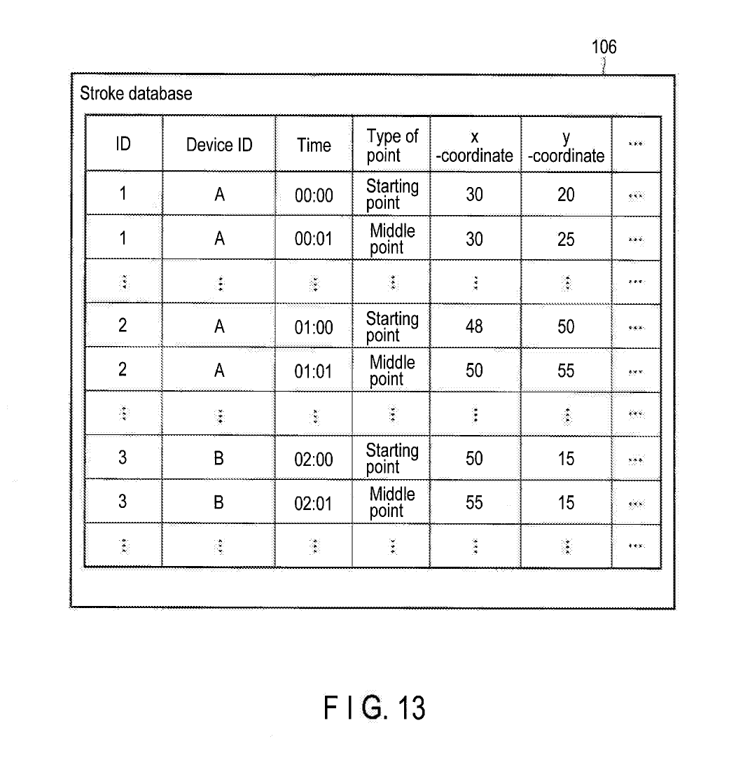

In the above explanation, one stroke data item is allocated for one record (in other words, each record is managed in a unit of a stroke data item). However, stroke data is the assembly of a plurality of sample point data items as described above. Therefore, as shown in, for example, FIG. 13, one sample point data item may be allocated for one record (in other words, each record may be managed in a unit of a sample point data item included in stroke data). In FIG. 13, the time indicates timestamp data T of the stroke data shown in FIG. 9.

When each stroke data item is managed in a unit of a sample point data item, the transmission/reception of stroke data in a collaboration operation can be performed in a unit of a sample point data item. In this configuration, it is possible to reproduce the way that strokes are made in more detail.

[Process flow]

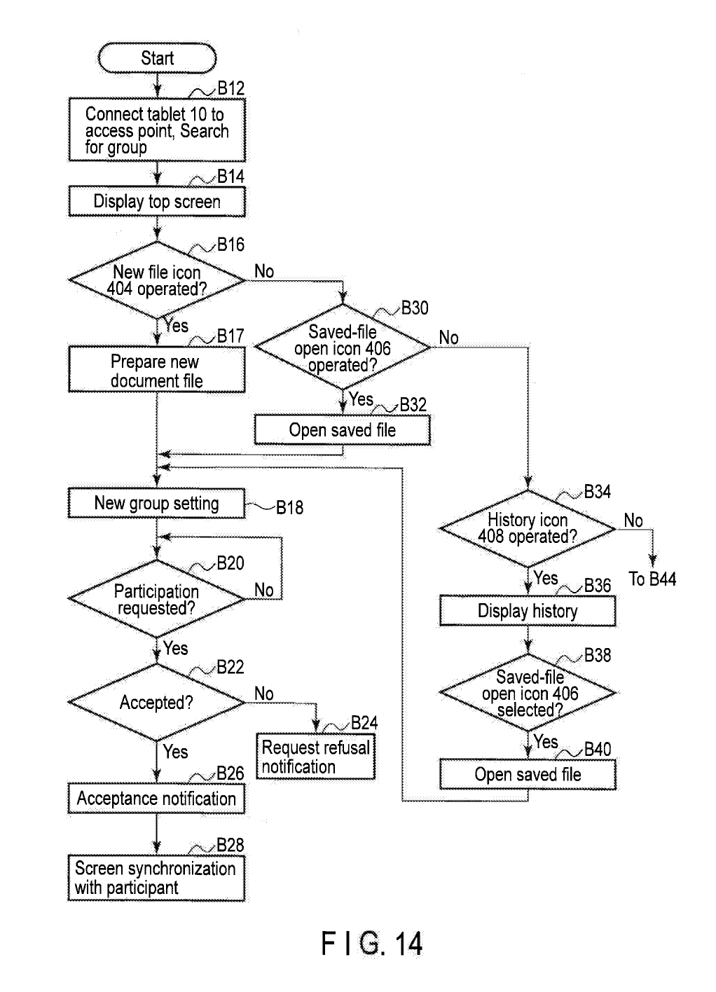

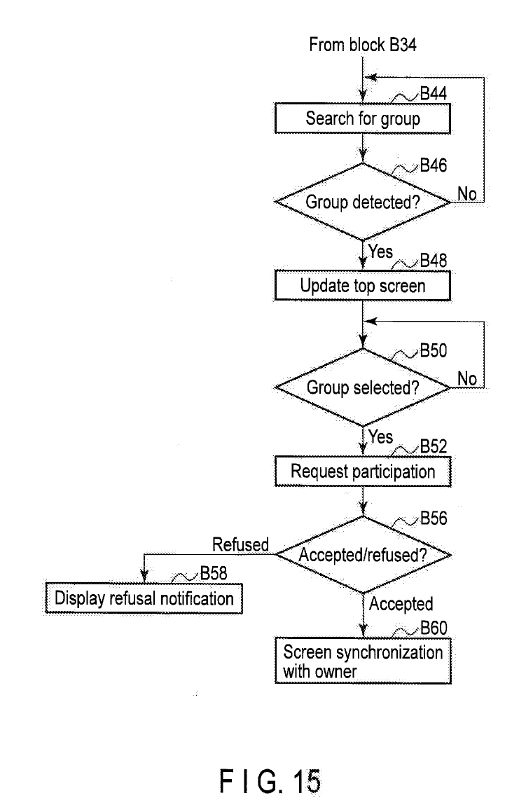

Now, this specification refers to the flowcharts of FIG. 14 and FIG. 15 and explains the flow of steps which are performed by the tablet 10 when the collaboration application program 203 of the tablet 10 is executed according to the present embodiment. It is assumed that the wireless connection between tablets is not direct connection and is performed using a wireless LAN via an access point.

As an example of the collaboration operation, it is assumed that a plurality of users, for example, three users, gather in a conference room with their respective tablets, and the collaboration application program 203 is activated.

When the application is activated, each tablet 10 is connected to the access point of a wireless LAN, and a search operation is performed regarding whether or not a group prepared by the user of another tablet connected to the access point is present (block B12). When a user creates a group and sets the group name, etc., this information is transmitted from the tablet of the user and may be detected in the other users' tablets connected to the same access point.

[User interface of top screen]

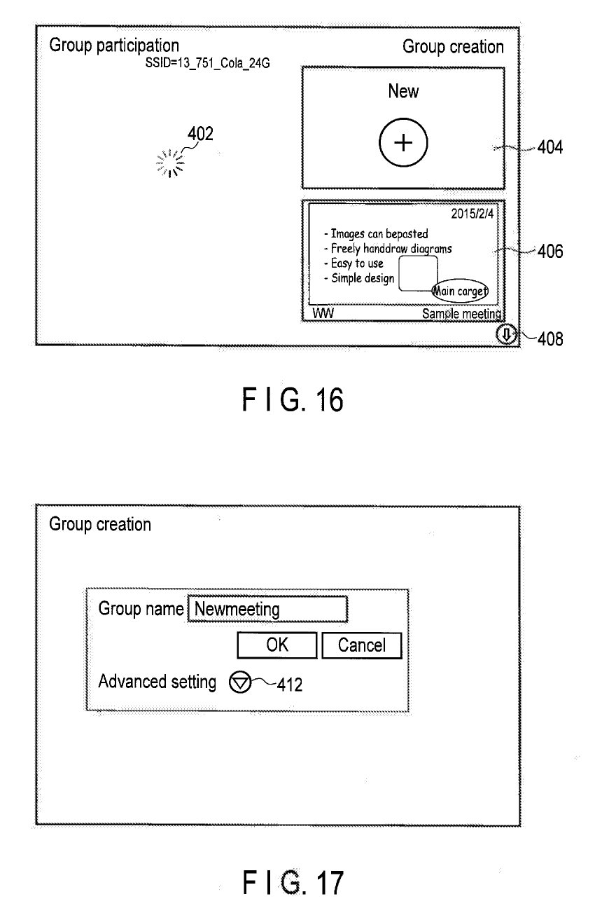

After the connection to the access point, the top screen exemplarily shown in FIG. 16 is displayed on the touch screen display 17 of the tablet 10 in block B14. The top screen may be displayed on the whole screen of the touch screen display 17 or may be displayed as a window in a part of the screen. A part of the top screen, for example, the left part of the top screen, is a group participation area for displaying information to participant in a group created by another user. In the group participation area, the icon of a group prepared by another user is displayed. Here, up to two icons can be displayed. During a search for a group created by another user, a retrieving icon 402 is displayed. The retrieving icon 402 is displayed in a form which allows the user to intuitively notice that a search is in progress. For example, the retrieving icon 402 blinks. If none of the three users has created a group immediately after the activation of the collaboration application, the retrieving icon 402 is displayed.

A part of the top screen, for example, the right part of the top screen, displays a new file icon 404 and a saved-file open icon 406 for creating a group as its owner. The new file icon 404 is an icon for creating a group which shares a new document. The saved-file open icon 406 is an icon for creating a group with the use of a document file which was shared in the past and stored in the nonvolatile memory 106 which is local storage. The new file icon 404 includes the mark “+” in the center, and the characters “New” above the mark. The saved-file open icon 406 displays a thumbnail showing the content of a document file stored in the nonvolatile memory 106. In the upper part of the thumbnail, the end date of sharing is displayed. In the lower part of the thumbnail, the owner name (WW) of the group and the group name (sample meeting) are displayed. When a plurality of document files are stored in the nonvolatile memory 106, only the latest document file is displayed as the saved-file open icon 406. The others are not displayed. A plurality of saved-files are stratified. When a history icon (button) 408 which is a downward arrow is touched, a predetermined number of document file icons one level down in the hierarchy are displayed as a history screen. In the central upper part of the screen, the SSID (=13_751_Cola_24G) of the connected access point is displayed.

There are two methods for creating a group as its owner. In a first method, a document is newly created at the time of group creation. Thus, a collaboration operation is started with a clean document. In a second method, a user opens a document which was created and shared in the past and was stored in the nonvolatile memory 106 which is a local storage. Thus, a collaboration operation is started with a document in which handwritten data has been already input. When a group is created by the first method, the new file icon 404 is touched. When a group is created by the second method, the saved-file open icon 406 is touched.

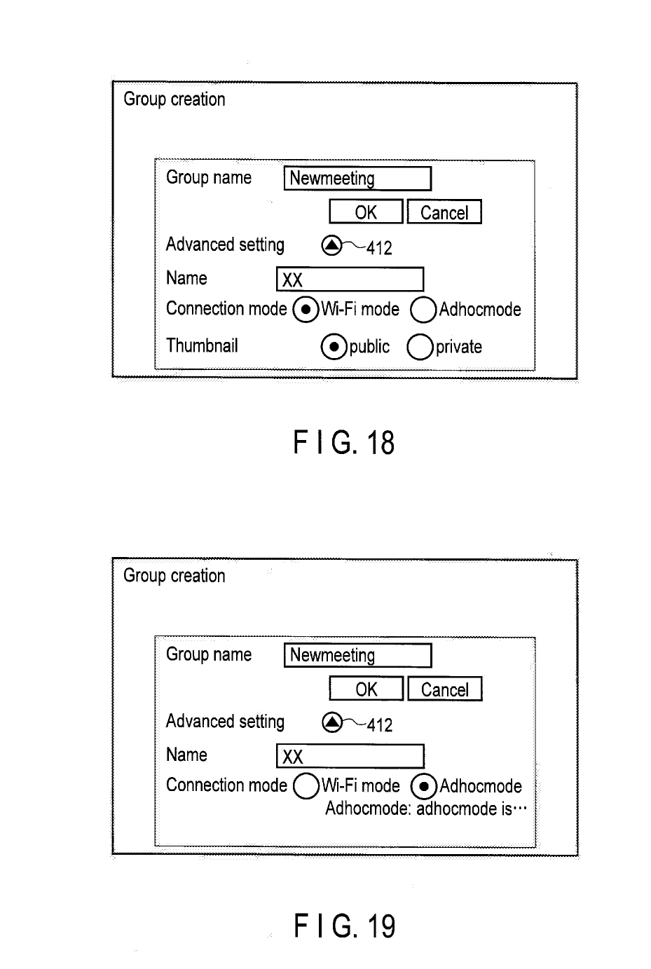

When a user wants to create a group as its owner and start sharing a new document, the new file icon 404 is touched. When the operation (touch operation) of the new file icon 404 is detected in block B16, a document file is newly prepared in block B17. In block B18, the top screen is switched to a group creation screen as exemplarily shown in FIG. 17. Thus, the user is allowed to determine various settings to create a group as its owner. The screen shown in FIG. 17 is a basic setting screen for only setting the group name. When an advanced setting icon (button) 412 is operated, the screen is changed to the advanced setting screen exemplarily shown in FIG. 18.

[User interface for group creation]

The advanced setting screen shown in FIG. 18 allows the user to set the owner name, the connection mode and the thumbnail. The group name and the owner name are also displayed in the saved-file open icon 406 and a member-inviting group icon described later. The owner can select the connection mode from a Wi-Fi (registered trademark) mode in which two tablets are connected via an access point and an ad-hoc mode in which two tablets are connected directly. Two tablets to be connected are the tablet of the owner and the tablet of a participant. The tablets of participants are not connected to each other. The owner can select the Wi-Fi (registered trademark) mode or the ad-hoc mode based on various standards. For example, the owner may select the connection mode based on the fixed number of members of the group (in other words, the number of connectable tablets). For example, it is possible to form a group of up to forty users in the Wi-Fi (registered trademark) mode, and it is possible to form a group of up to five users in the ad-hoc mode. In an environment in which an access point is not present such as an outdoor place, the owner is forced to select the ad-hoc mode. If there is a connectable access point at a nearby site, the tablets of the users other than the owner are connected to the access point regardless of the connection mode set by the owner. If there is no connectable access point at a nearby site, the tablets of the users other than the owner are directly connected to another tablet regardless of the connection mode set by the owner.

In the thumbnail setting, the owner specifies whether or not the thumbnail of the document file should be displayed in the member-inviting group icon described layer. A user who views the member-inviting group icon is not a participant of the group yet. The disclosure of the thumbnail to such a user may be undesirable in terms of protection of privacy. If the item “private” is selected in the thumbnail setting, the thumbnail is not displayed in the member-inviting group icon. If the item “public” is selected, the thumbnail is displayed in the member-inviting group icon. The outline of the document file can be easily understood. Thus, the convenience is improved at the time of group participation.

The thumbnail setting may not be always available. The thumbnail setting may be available only when the connection mode is the Wi-Fi (registered trademark) mode, and the thumbnail setting may not be available when the connection mode is the ad-hoc mode. In this case, if the ad-hoc mode is selected on the advanced setting screen, the thumbnail setting may not be displayed on the advanced setting screen as exemplarily shown in FIG. 19.

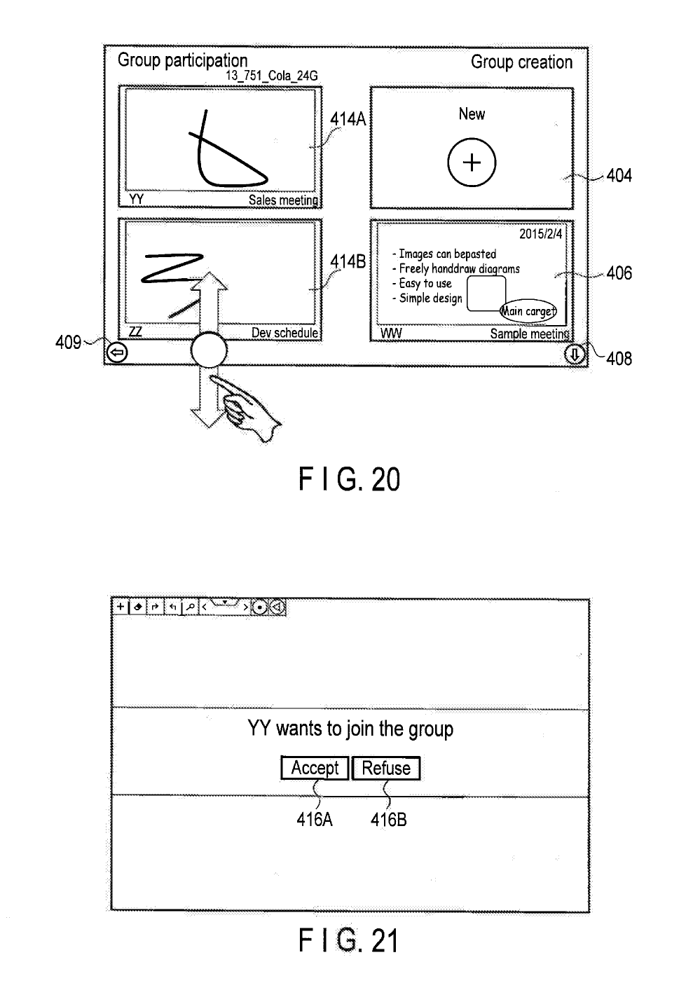

After the settings for group creation are completed on the tablet of the owner in block B18, the setting information related to the created group is transmitted from the tablet of the owner. When the information is received by the tablet of each user other than the owner, the group which is inviting members is detected. As exemplarily shown in FIG. 20, the retrieving icon 402 in the left part is deleted from the top screen of the tablet of each user other than the owner. Instead, for example, member-inviting group icons 414A and 414B are displayed on top screen. The number of the left member-inviting group icons 414 is not limited to one. When a plurality of groups are currently inviting members, one or more group icons 414A and 414B corresponding to one or more member-inviting groups are displayed. FIG. 20 shows an example in which two users YY and ZZ created groups “sales meeting” and “development meeting”, respectively, and are inviting members. On the screen, only the two member-inviting group icons 414A and 414B are displayed. However, all the created member-inviting group icons are displayed by swiping the screen up and down. As stated above, for example, the owner name and the group name are essential for the member-inviting group icons 414; however, the owner can determine whether or not the thumbnail should be displayed.

When a user selects a group in which the user wants to participate or a group which is requested from the owner to participate in (in other words, when a user touches member-inviting group icon 414A or 414B) on the tablet displaying the top screen of FIG. 20, a participation request including the information of the participation applicant is transmitted from the tablet of the applicant to the tablet of the owner in block B20. After the tablet of the owner receives the participation request information, a participation request screen is displayed on the touch screen display 17 in block B22 as exemplarily shown in FIG. 21. The participation request screen includes a message which specifies the participation applicant, such as “YY wants to join the group”, and icons (buttons) 416A and 416B for allowing the owner to accept or refuse the request. The owner operates one of the accept icon 416A and the refuse icon 416B.

When the refuse icon 416B is operated, a request refusal notification is transmitted from the tablet of the owner to the tablet of the applicant in block B24. Further, for example, a message indicating that the request has been refused is displayed on the touch screen display 17 of the tablet of the applicant.

When the accept icon 416A is operated, a request acceptance notification is transmitted from the tablet of the owner to the tablet of the applicant in block B26. Further, for example, a message indicating that the request has been accepted is displayed on the touch screen display 17 of the tablet of the applicant.

[User interface of screen synchronization]

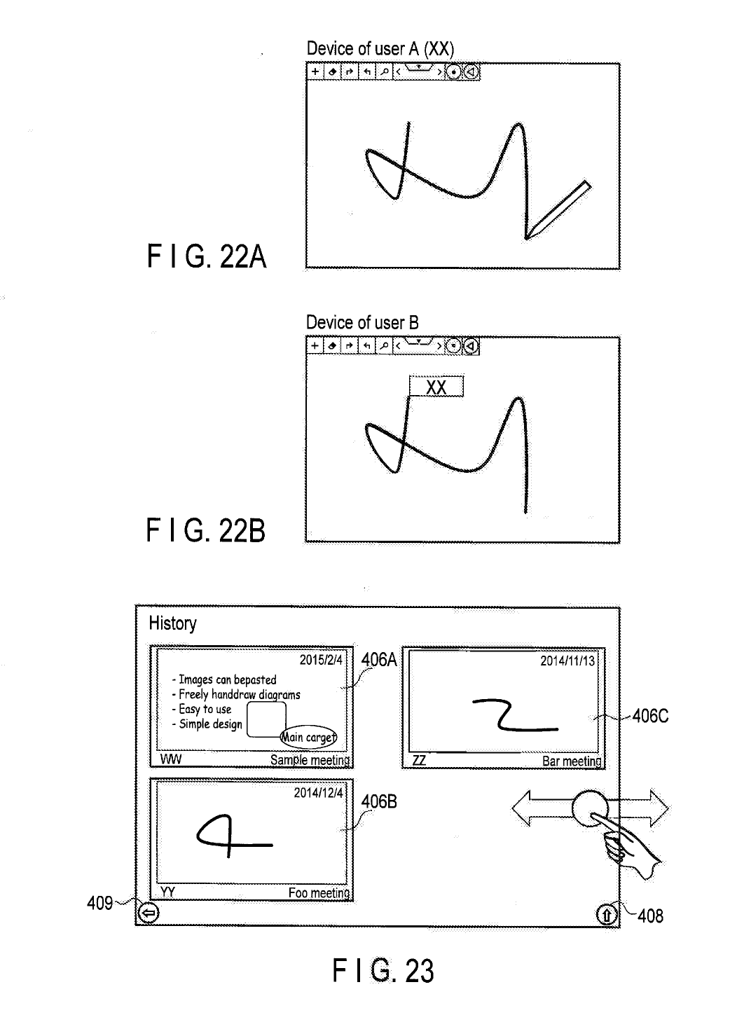

When the request from another user is accepted, screen synchronization is performed between the tablet of the participant and the tablet of the owner in block B28 as exemplarily shown in FIGS. 22A and 22B. FIG. 22A shows the screen of the owner, for example, user A (XX). FIG. 22B shows the screen of the participant, for example, user B (YY). When the owner handwrites a stroke, the handwritten stroke of the owner is displayed on the screen of the owner as shown in FIG. 22A. Moreover, as shown in FIG. 22B, the same handwritten stroke is displayed on the screen of the participant, and further, the name of the writer is displayed near the starting point of the stroke while the stroke is handwritten (from the stylus touch to the stylus release). When the strokes of a plurality of users are inputted on the screen by the collaboration function, the writer of each strokes is displayed on the screen. Therefore, the users can notice the writer of each strokes and smoothly communicate with each other in a meeting, etc. The name of the writer is displayed for each stroke. If the name of the writer is displayed at all times while the stroke is handwritten, the screen is difficult to view. Thus, the name of the writer may be displayed only in a short period specified by the user. Instead of, or in addition to, the display of the name of the writer, for example, the color or type of strokes may be changed depending on the writer such that the writer can be identified.

As described above, after a user creates a group as its owner, the information related to the group is transmitted from the device of the owner to the other devices connected to the access point connected to the device of the owner. Further, an icon indicating that the group is inviting members is displayed in the other devices. The users of the other devices can easily participate in the group created by another user by selecting the icon. The owner can easily invite participants in the group.

When the operation (touch operation) of the new file icon 404 is not detected in block B16, it is determined in block B30 whether or not the saved-file open icon 406 is operated on the top screen (shown in FIG. 16 or FIG. 20). When the saved-file open icon 406 is operated, a document file which was created and shared in the past, was stored in the nonvolatile memory 106 which is local storage and corresponds to the saved-file open icon 406 opens in block B32. Subsequently, in block B18, a group setting operation is performed by the owner. In this manner, a group is created to share a document which was shared in the past and stored in local storage.

The owner of the group which shared the document file corresponding to the saved-file open icon 406 may be a different user. However, when the saved-file open icon 406 is operated, a group is created such that the user who operated the icon becomes the owner of the group. Sharing of the document in the new group is started. Thus, the owner of the new group which shares the document may be different from the owner of the group which shared the document in the past. In addition, the participants of the new group which shares the document may be different from the participants of the group which shared the document in the past.

When the saved-file open icon 406 is not operated in block B30, it is determined in block B34 whether or not the history icon 408 is operated on the top screen (shown in FIG. 16 or FIG. 20). When the history icon 408 is operated, a predetermined number of, for example, three (up to four) saved-file icons 406A, 406B and 406C one level down in the hierarchy are displayed as the history screen in block B36 as exemplarily shown in FIG. 23. Other saved-file icons are displayed by swiping the screen left and right. When the history icon 408 is operated in this state, a predetermined number of saved-file icons further one level down in the hierarchy are displayed.

When one of the saved-file icons is selected in block B38, a document file which is stored in the nonvolatile memory 106 and corresponds to the icon opens in block B40. Subsequently, in block B18, a group setting operation is performed by the owner. A group is created to share a document which was shared in the past and stored in local storage. In this manner, sharing of the document in the new group is started.

Thus, the icon of a saved-file which was shared in the past is displayed. Therefore, the user can easily create a new group with the past document by merely touching the icon. Even if the file was shared by a group created by another person, the file can be shared by a group created by the user as its owner.

When the history icon 408 is not operated in block B34, a search is performed again regarding whether or not there is a group created by the user of another tablet connected to the access point connected to the self-tablet in block B44 (FIG. 15). When such a group is detected in block B46, the top screen is updated in block B48. As shown in FIG. 20, the top screen is changed so as to include member-inviting group icons 414A and 414B. When the user selects a group in which the user wants to participate or a group requested from the owner to participate in (in short, the user touches group icon 414A or 414B) in block B50, a participation request including the information of the applicant is transmitted from the tablet of the user to the tablet of the owner in block B52.

The user waits for the notification of acceptance or refusal for the participation from the owner in block B56. In a case of refusal, a refusal notification is displayed in block B58. In a case of acceptance, an acceptance notification is displayed in block B60. Subsequently, the screen of the owner is synchronized with that of the participant as exemplarily shown in FIGS. 22A and 22B.

When a desired operation is not performed in block B20, B46 or B50, etc., the steps of these blocks are repeated. Thus, the process may not proceed. To avoid such a situation, a return button 409 may be prepared as shown in, for example, FIG. 20 and FIG. 23. When the return button 409 is pressed, an interrupt is generated in the flowcharts of FIG. 14 and FIG. 15. The displayed screen returns to the top screen of block B14 in FIG. 14.

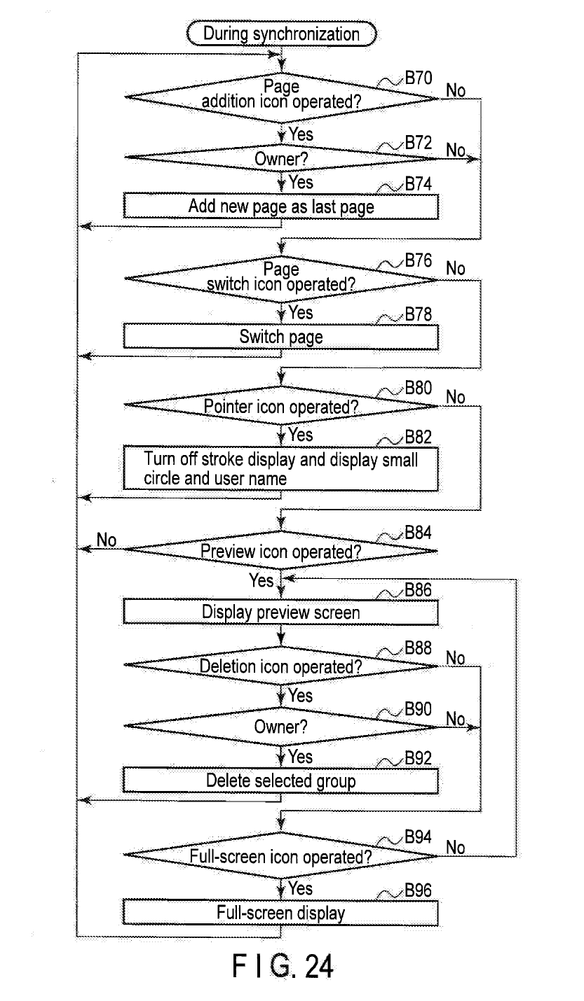

The flowcharts of FIG. 14 and FIG. 15 relate to an operation which is performed immediately after the activation of the collaboration application program 203 until group creation and group participation. An operation which is performed during synchronization (FIGS. 22A and 22B) after group creation is explained with reference to the flowchart of FIG. 24.

[Process flow during synchronization]

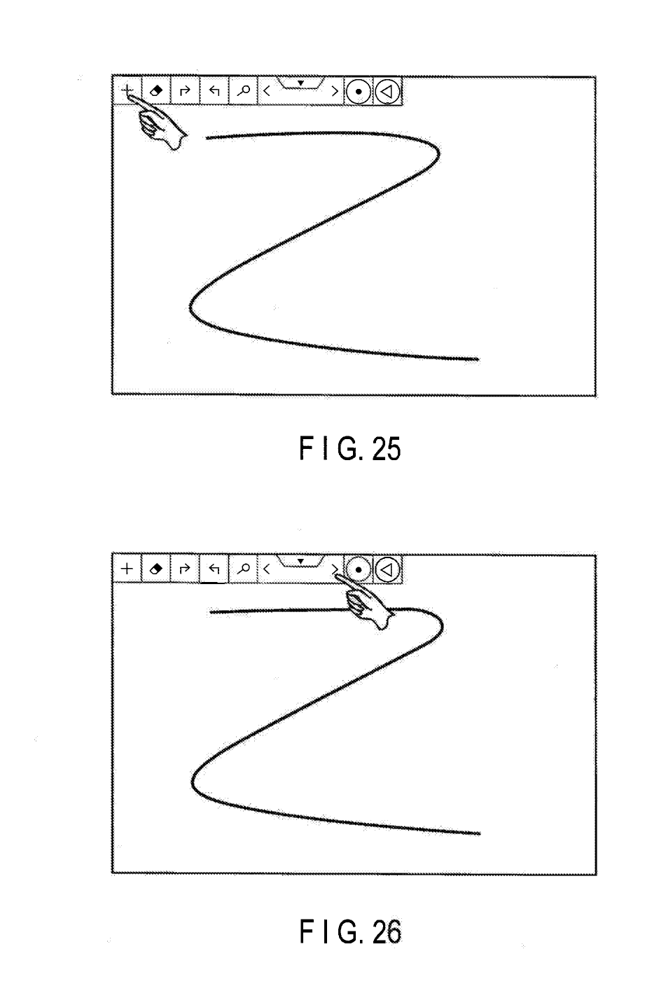

In block B70, it is determined whether or not a page addition icon is operated. As exemplarily shown in FIG. 25, some icons are displayed in the upper left part of the screen during synchronization. The leftmost icon “+” is the page addition icon. When the page addition icon is operated, it is determined in block B72 whether or not the tablet in which the page addition icon is operated is the tablet of the group owner. The reason is that only the owner is assumed to be authorized to add a page to the document shared by the group. However, all the members in the group may be authorized to add a page. When the page addition icon is operated on the tablet of the owner, a new page is added to a predetermined portion which can be set by the user in the document, for example, as the last page, in block B74. The process returns to the determination of block B70. The page addition on the tablet of the owner is reflected in the document file stored in the tablet of each participant.

When the page addition icon is not operated in block B70, or when the tablet in which the page addition icon is operated is not the tablet of the group owner in block B72, the process proceeds to block B76. In block B76, it is determined whether or not a page switch icon is operated. As exemplarily shown in FIG. 26, of the icons displayed in the upper left part of the screen during synchronization, the icon “<” or “>” is the page switch icon. When the page switch icon is operated, the page of the shared document displayed on the screen is switched in block B78. When the page is switched on the tablet of the owner, basically, the displayed page of each participant is also switched. However, when the page is switched on the tablet of a participant, the displayed page of the other tablets (including the tablets of the owner and the other participants) is not switched. Therefore, the tablets of a plurality of participants may display different pages in the same document. After block B78 is finished, the process returns to block B70.

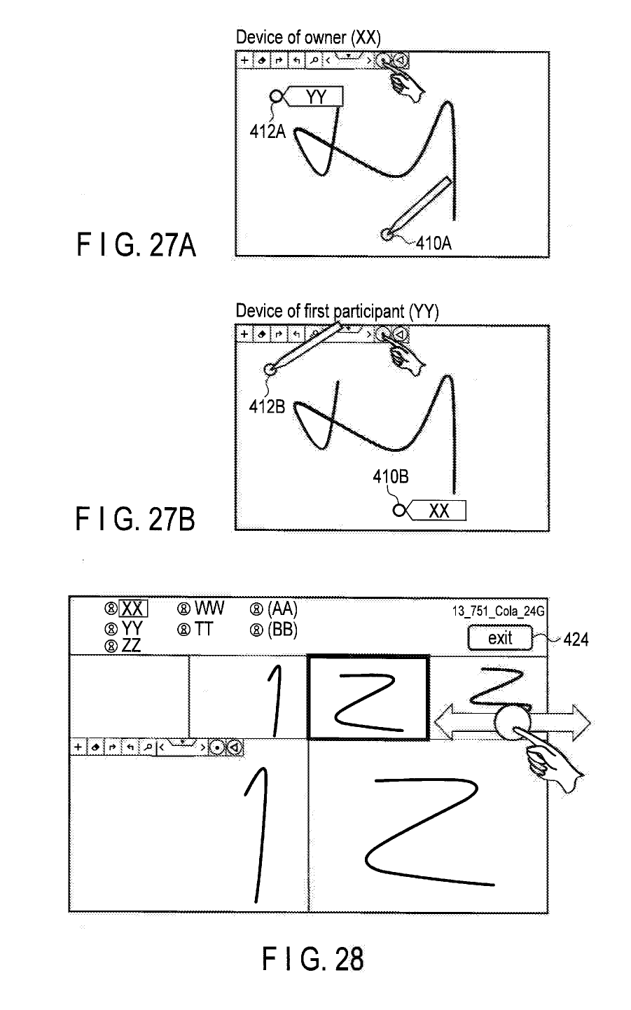

When the page switch icon is not operated in block B76, the process proceeds to block B80. In block B80, it is determined whether or not a pointer icon is operated. As exemplarily shown in FIGS. 27A and 27B, of the icons displayed in the upper left part of the screen during synchronization, the icon “•” is the pointer icon. When the pointer icon is operated, the stroke display mode is turned off, and further, a small circle and the user name are displayed in the contact position of the stylus in block B82. FIG. 27A shows the screen of the tablet of the owner, for example, XX. FIG. 27B shows the screen of the tablet of a participant, for example, YY. When the owner brings the stylus into contact with the lower central part of the screen after touching the pointer icon, a circle 410A is displayed on the contact point. Further, a circle 410B and the owner name (XX) are displayed in a corresponding position on the screen of the participant. In a similar manner, when the participant brings the stylus into contact with the upper left part of the screen after touching the pointer icon, a circle 412B is displayed on the contact point. Further, a circle 412A and the participant name (YY) are displayed in a corresponding position on the screen of the owner. The mark displayed on the contact point is not limited to a circle. Any mark can be employed as long as it indicates the position. After the pointer mode is turned off, and returns to the normal stroke input mode, the display of the circle indicating the contact position of the stylus is finished. After block B82 is finished, the process returns to block B70.

Thus, the users can smoothly communicate with each other in a meeting, etc., by temporarily stopping the input of strokes and displaying a predetermined mark instead of strokes.

When the pointer icon is not operated in block B80, the process proceeds to block B84. In block B84, it is determined whether or not a preview icon of the icons displayed in the upper left part of the screen during synchronization is operated. When the preview icon is not operated, the process returns to block B70. When the preview icon is operated, a preview screen is displayed in block B86 as exemplarily shown in FIG. 28. The page displayed in full-screen in the document during synchronization is scaled down and is displayed in the lower left part of the screen. On the right side of this page, the next page is displayed with reduced size. Above the reduced display of these two pages, four pages are displayed with reduced size. Of the reduced display of the four pages, the second and third pages are displayed in the lower stage with reduced size as two pages. The reduced display of the four pages may be swiped sideways. By this operation, other pages can be displayed.

The names of the members of the group corresponding to the document are displayed in the upper left part of the preview screen. XX in a frame is the owner of the group. YY, ZZ, WW and TT are the participants (at the moment). AA and BB in brackets are the past participants who left the group. An icon (button) 424 for leaving the group is displayed in the upper right part of the screen.

[User interface of preview screen]

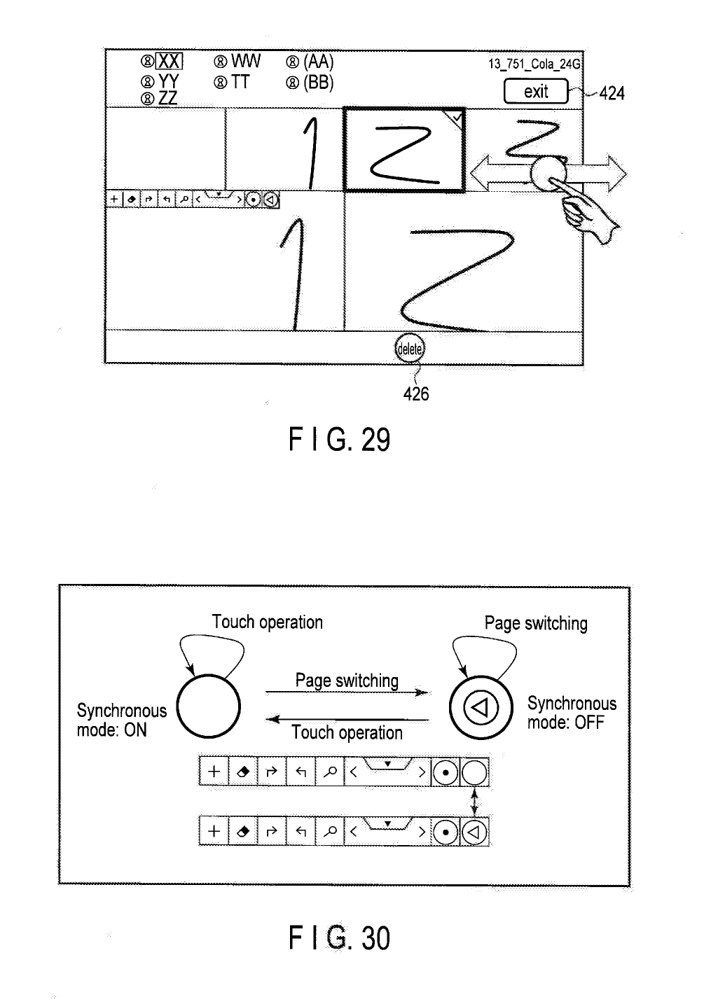

When a page is selected on the preview screen, as exemplarily shown in FIG. 29, the display form of the selected page is changed (here, a black frame is added, and a check is added to the upper right part), and further, a deletion icon 426 is displayed in the lower part of the screen. When the operation of the deletion icon 426 is detected in block B88, it is determined in block B90 whether or not the tablet in which the page deletion icon 426 is operated is the tablet of the group owner. The reason is that only the owner is assumed to be authorized to delete a page from the document shared by the group. However, all the members of the group may be authorized to delete a page. When the page deletion icon is operated on the tablet of the owner, the page selected in FIG. 29 is deleted (a plurality of pages may be deleted) in block B92. The process returns to the determination of block B70. The page deletion on the tablet of the owner is reflected on the document file stored in the tablet of each participant.

When the deletion icon is not operated in block B88, or when the tablet in which the page deletion icon is operated is not the tablet of the group owner in block B90, the process proceeds to block B94. In block B94, it is determined whether or not a full-screen icon of the icons displayed in the upper left part of the screen during synchronization is operated. When the full-screen icon is not operated, the process returns to block B86. When the full-screen icon is operated, the preview screen returns to the full-screen display in block B96. After block B96, the process returns to block B70.

Thus, a plurality of pages are displayed at the same time. The user-convenience is improved at the time of page switching, deletion, etc.

By the collaboration function, the screens may be synchronized on the tablets of the users in the same group. The page displayed on the tablet of the owner is referred to as a main view. When the page viewed by the owner is switched, and thus, the main view is changed, the page displayed on the screen of each participant is changed in association with the change in the screen of the owner. When a writing operation is performed in progress by a participant, page switching of the screen may, in some cases, be delayed until the writing operation is finished. Therefore, the displayed page of the screen of the participant is switched in association with the main view after the elapse of several seconds from the time point when the stylus of the participant is separated from the screen.

[User interface of page synchronization]

As stated above, a participant can individually switch the page. Therefore, a participant may not be comfortable if the screen of the participant is switched so as to always coincide with the screen of the owner. To prevent this inconvenience, a synchronous mode for switching the page of the screen of a participant in association with the page switching on the screen of the owner is set so as to be easily turned on or off by the participant. FIG. 30 exemplarily shows an enlarged view of icons displayed in the upper left part of the screen of a participant during synchronization. The rightmost icon “∘” is a synchronous icon for turning the synchronous mode on or off. This specification explains the state transition of the tablet of a participant in relation to the operation of the synchronous icon. When the synchronous mode is in an on-state, the icon only shows “∘”. When the synchronous mode is in an off-state, the icon is shaped such that a left-pointing triangle is inserted into “∘”.

In the on-state of the synchronous mode, even when the synchronous icon is touched, the state is not changed. The on-state of the synchronous mode is carried on. In the on-state of the synchronous mode, when the main view of the owner is changed, the screen of the participant is changed in association with the change in the screen of the owner. In the on-state of the synchronous mode, when the page is switched on the tablet of the participant, the synchronous mode is turned off. In the off-state of the synchronous mode, the screen of the participant is not changed in association with the switching on the screen of the owner. Thus, the page viewed by a participant may be different from the page viewed by the owner.

In the off-state of the synchronous mode, when the synchronous icon is touched, the synchronous mode is turned on. In the off-state of the synchronous mode, even when the page is switched, the state is not changed. The page is merely switched to the page specified by the user.

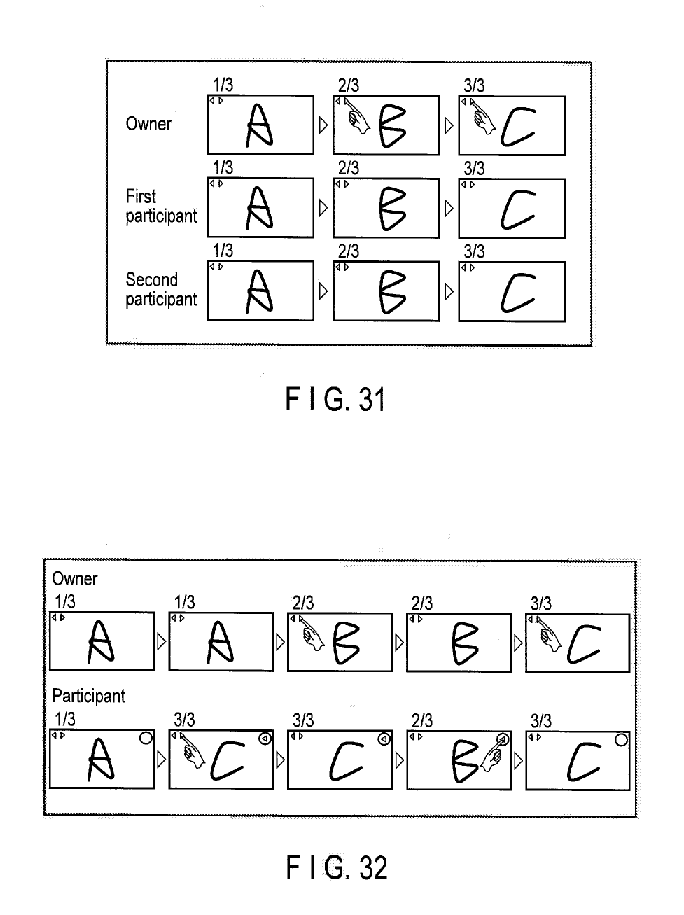

FIG. 31 exemplarily shows the transition of the screen of the owner and the screens of first and second participants when the synchronous mode is in an on-state. The document is assumed to consist of three pages. In the initial stage of the collaboration operation, the same page (a first page) is displayed on the screens of the owner, the first participant and the second participant. The owner switches the view page by a page switching operation as shown in FIG. 26. By this switching, a second page is displayed on the screen of the owner. Since the synchronous mode is in an on-state, the screens of the first and second participants are changed in association with the change in the screen of the owner. In this manner, the second page is displayed on the screens of the first and second participants. In a similar manner, when the owner switches the view page by a page switching operation, and a third page is displayed on the screen of the owner, the screens of the first and second participants are changed in association with the change in the screen of the owner. In this manner, the third page is displayed on the screens of the first and second participants.

When the main view is changed, the page displayed on the screen of each participant is changed in association with the change in the screen of the owner. When a writing operation is performed in progress by a participant, page switching on the screen is preferably delayed until the writing operation is finished. Therefore, the displayed page of the screen of the participant is switched in association with the main view after the elapse of several seconds from the time point when the stylus of the participant is separated from the screen.

FIG. 32 exemplarily shows the transition of the screen of the owner and the screen of a participant when the synchronous mode is in an off-state. In the initial stage of the collaboration operation, the same page (the first page) is displayed on the screens of the owner and the participant. The participant switches the view page by a page switching operation as shown in FIG. 26. By this switching, the third page is displayed on the screen of the participant. The screen of the owner continues to display the first page. The owner switches the view page by a page switching operation as shown in FIG. 26. By this switching, the second page is displayed on the screen of the owner. Since the synchronous mode is in an off-state, the screen of the participant is not associated with the change in the screen of the owner. The screen of the participant continues to display the third page.

When the participant touches the synchronous icon, the synchronous mode is turned on the tablet of the participant. Subsequently, in a manner similar to that of FIG. 31, the owner switches the view page by a page switching operation as shown in FIG. 26. By this switching, the third page is displayed on the screen of the owner. In association with the change in the screen of the owner, the third page is displayed on the screen of the participant.

Thus, the screen of the participant coincides with the screen of the owner only when the synchronous mode is in an on-state. When the synchronous mode is in an off-state, the screen of the participant is not associated with the screen of the owner, and the participant can freely switch the displayed page. In this manner, the convenience of the participant is improved.

### Variations of Embodiments

An electronic apparatus comprises a display, a memory, and a hardware processor. The display is capable of detecting handwriting that is inputted on a screen of the display. The memory is configured to store a first document comprising first strokes and created by a first apparatus group comprising the electronic apparatus and a first electronic apparatus. Some of the first strokes are inputted on the screen and some other of the first strokes are inputted on the first electronic apparatus. The hardware processor configured to (1) display, on the screen, a first icon that, when selected, initiates creation of a second apparatus group comprising at least the electronic apparatus; (2) display the first document on the screen in response to a creation of the second apparatus group; (3) modify the first document to include first additional strokes in response to receiving the first additional strokes, wherein some of the first additional strokes are inputted on the screen and wherein some other of the first additional stroke are inputted on a second electronic apparatus belonging to the second apparatus group; (4) display, on the screen, a second icon that, when selected, initiates a request to participate in a third apparatus group comprising a third electronic apparatus and a fourth electronic apparatus; (5) join the third apparatus group and display a second document comprising second strokes and created by the third apparatus group on the screen in response to selecting the second icon and receiving authorization to join the third apparatus group, wherein some of the second strokes are inputted on the third electronic apparatus and wherein some other of the third strokes are inputted on the fourth electronic apparatus; and (6) modify the second document to include second additional strokes in response to receiving the second additional strokes, wherein some of the second additional strokes are inputted on the screen and wherein some other of the second additional strokes are inputted on at least one of the third electronic apparatus and the fourth electronic apparatus.

As explained above, the embodiments described herein provide an electronic device, a method and a storage medium for easily forming the group of a plurality of users of electronic devices which enable handwriting in order to easily share a handwriting operation and screen display with the electronic devices of the other users in the same group.

Each of the various functions described in the embodiments may be realized by a processing circuit. The processing circuit includes a programmed processor such as a central processing unit (CPU). This processor performs each of the above functions by executing a program stored in a memory. The processor may be a microprocessor including an electronic circuit. For example, the processing circuit may be a digital signal processor (DSP), an application specific integrated circuit (ASIC), a microcontroller, a controller and other electronic circuit components.

Each process of the embodiments can be realized by a computer program. Therefore, an effect similar to that of the embodiments can be easily realized by merely installing the computer program into a computer through a computer-readable storage medium in which the computer program is stored and executing the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the inventions. For example, the screen examples of a tablet in FIG. 16 to FIG. 23 and FIG. 25 to FIG. 30 are merely examples, and may be modified without departing from the spirit of the embodiments. For example, the position of each icon or button is not limited to the above embodiments. Each icon or button may be appropriately omitted. Further, a different icon or button may be appropriately added.

What is claimed is:

1. An electronic apparatus comprising:
a display capable of detecting handwriting that is inputted on a screen of the display;
a memory configured to store a first document comprising first strokes and created by a first apparatus group comprising the electronic apparatus and a first electronic apparatus, wherein some of the first strokes are inputted on the screen and wherein some other of the first strokes are inputted on the first electronic apparatus; and
a hardware processor configured to:
display, on the screen, a first icon that, when selected, initiates creation of a second apparatus group comprising at least the electronic apparatus;
display the first document on the screen in response to a creation of the second apparatus group;
modify the first document to include first additional strokes in response to receiving the first additional strokes, wherein some of the first additional strokes are inputted on the screen and wherein some other of the first additional stroke are inputted on a second electronic apparatus belonging to the second apparatus group;
display, on the screen, a second icon that, when selected, initiates a request to participate in a third apparatus group comprising a third electronic apparatus and a fourth electronic apparatus;
join the third apparatus group and display a second document comprising second strokes and created by the third apparatus group on the screen in response to selecting the second icon and receiving authorization to join the third apparatus group, wherein some of the second strokes are inputted on the third electronic apparatus and wherein some other of the third strokes are inputted on the fourth electronic apparatus; and
modify the second document to include second additional strokes in response to receiving the second additional strokes, wherein some of the second additional strokes are inputted on the screen and wherein some other of the second additional strokes are inputted on at least one of the third electronic apparatus and the fourth electronic apparatus.

2. The electronic apparatus of claim 1, wherein the first icon comprises a first thumbnail image depicting the first document.

3. The electronic apparatus of claim 1, wherein the hardware processor is further configured to annotate the second additional strokes that are inputted on at least one of the third electronic apparatus and the fourth electronic apparatus with a mark identifying a user who input the second additional strokes.

4. The electronic apparatus of claim 1, wherein the second icon comprises a second thumbnail image depicting the second document.

5. The electronic apparatus of claim 1, wherein the second document comprises a first page and a second page, and wherein the hardware processor is further configured to switch from displaying the first page on the screen to displaying the second page on the screen without receiving user input and in response to the third electronic apparatus switching from displaying the first page to displaying the second page.

6. The electronic apparatus of claim 1, wherein the hardware processor is further configured to:
determine a first position of a first pointer in accordance with a second position of a second pointer, wherein the second pointer designates a position of the second document on the third electronic apparatus;
display the first pointer at the first position of the second document on the screen; and
move the first pointer in accordance with a movement of the second pointer.

7. A method performed by an electronic apparatus, the method comprising:
storing, in a memory, a first document comprising first strokes and created by a first apparatus group comprising the electronic apparatus and a first electronic apparatus, wherein some of the first strokes are inputted on the screen and wherein some other of the first strokes are inputted on the first electronic apparatus;
displaying, on a screen, a first icon that, when selected, initiates creation of a second apparatus group comprising at least the electronic apparatus;
displaying the first document on the screen in response to a creation of the second apparatus group;
modifying the first document to include first additional strokes in response to receiving the first additional strokes, wherein some of the first additional strokes are inputted on the screen and wherein some other of the first additional stroke are inputted on a second electronic apparatus belonging to the second apparatus group;
displaying, on the screen, a second icon that, when selected, initiates a request to participate in a third apparatus group comprising a third electronic apparatus and a fourth electronic apparatus;
joining the third apparatus group and displaying a second document comprising second strokes and created by the third apparatus group on the screen in response to selecting the second icon and receiving authorization to join the third apparatus group, wherein some of the second strokes are inputted on the third electronic apparatus and wherein some other of the third strokes are inputted on the fourth electronic apparatus; and
modifying the second document to include second additional strokes in response to receiving the second additional strokes, wherein some of the second additional strokes are inputted on the screen and wherein some other of the second additional strokes are inputted on at least one of the third electronic apparatus and the fourth electronic apparatus.

8. The method of claim 7, wherein the first icon comprises a first thumbnail image depicting the first document.

9. The method of claim 7, further comprising annotating the second additional strokes that are inputted on at least one of the third electronic apparatus and the fourth electronic apparatus with a mark identifying a user who input the second additional strokes.

10. The method of claim 7, wherein the second icon comprises a second thumbnail image depicting the second document.

11. The method of claim 7, wherein the second document comprises a first page and a second page, and wherein the method further comprises switching from displaying the first page on the screen to displaying the second page on the screen without receiving user input and in response to the third electronic apparatus switching from displaying the first page to displaying the second page.

12. The method of claim 7, further comprising
determine a first position of a first pointer in accordance with a second position of a second pointer, wherein the second pointer designates a position of the second document on the third electronic apparatus;
displaying the first pointer at the first position of the second document on the screen; and
moving the first pointer in accordance with a movement of the second pointer.
